(19) United States
(12) Patent Application Publication
(10) Pub. No.: US 2011/0296193 A1
(43) Pub. Date: Dec. 1, 2011

(54) CODE-BASED HASHING FOR MESSAGE AUTHENTICATION CODES

(75) Inventors: Khaled Soliman Alghathbar, Riyadh (SA); Alaaeldin M. Hafez, Riyadh (SA); Hanan Ahmed Hossni Mahmoud Abd Alla, Riyadh (SA)

(73) Assignee: King Saud University, Riyadh (SA)

(21) Appl. No.: 12/790,730

(22) Filed: May 28, 2010

(51) Int. Cl. H04L 9/32

(52) U.S. Cl. 713/181

(57) ABSTRACT

Code-based hashing for message authentication code generation is described. In one aspect, a computer-implemented method receives a message and a secret key. A hash function is built based on respective portions of the secret key and a language interpreter. A formatted message is hashed using the hash function to generate a message authentication code for authentication of the message.

### BACKGROUND

Verifying integrity and authentication of information are important, fundamental issues that should be considered in computer systems and networks. Authenticity of such information should be verified, especially when it transferred through communication channels. For example, two parties communicating over an insecure channel require a method by which information sent by one party can be validated as authentic (or unmodified) by the receiving party. Additionally, authentication verification techniques are required to verify that information in computer systems (e.g., data in a database, or other archive) is authentic and has not been unintentionally or maliciously altered. In addition to detecting malicious attacks, integrity checks also identify data corrupted information. Message authentication code (MAC) algorithms are keyed hash functions whose specific purpose is message authentication. In most cases, MAC techniques use iterated hash functions, and those techniques are called iterated MACs. Such techniques usually use a MAC key that is used as an input to the compression function, and is involved in the compression function f at every stage. A wide range of authentication techniques use un-keyed hash functions, which are known as modification detection codes (MDCs). MD4, MD5, SHA-1 and RIPEMD-160 are some of many. Recently, powerful new attacks on hash functions such MD5 and SHA-1, among others, suggest introducing more secure hash functions.

### SUMMARY

Code-based hashing for message authentication code generation is described. In one aspect, a computer-implemented method receives a message and a secret key. A hash function is built based on respective portions of the secret key and a language interpreter. A formatted message is hashed using the hash function to generate a message authentication code for authentication of the message.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary system for code-based hashing for message authentication code generating algorithms, according to one embodiment.

FIG. 2 shows an exemplary procedure for code-based hashing for message authentication algorithms, according to one embodiment.

FIG. 3 is a block diagram illustrating exemplary logic dataflow for code-based hashing for message authentication, according to one embodiment. In particular, the block diagram illustrates exemplary aspects of a hash function used with a secret key for a MAC algorithm according to the operations described herein.

FIG. 4 shows exemplary data flow of the processing and interpreter portions of the compression logic for code-based hashing for message authentication, according to one embodiment.

FIG. 5 is a block diagram illustrating an exemplary procedure for code-based hashing for message authentication algorithms, according to one embodiment.

FIG. 6 is a flowchart showing further exemplary aspects of the procedure of FIG. 5 directed to code-based hashing for message authentication algorithms, according to one embodiment.

FIG. 7 is a flowchart showing further exemplary aspects of the procedure of FIG. 5 and FIG. 6 directed to code-based hashing for message authentication algorithms, according to one embodiment.

FIG. 8 is a flowchart that shows further exemplary aspects of the exemplary procedure of FIGS. 5 through 7 for code-based hashing for message authentication algorithms, according to one embodiment.

### DETAILED DESCRIPTION

### Overview

There are two major approaches to implement authentication/integrity mechanisms, the use of digital signature and the use of message authentication code.

In the digital signature approach, public key cryptography is used, which is the use of a public key and a private key. A sender signs a message digitally by computing a hash function (or checksum) over the data, and then encrypts the hash function value using the private key. The encrypted hashing value is sent to the receiver accompanied with the data. The receiver would verify the authenticity of the received data by recalculating the hash function and decrypting the transmitted hashing value using the public key. The two hash values are compared, if matched then the message is authentic and came from the claimed sender.

Regarding use of a Message Authentication Code (MAC), a shared secret key is used instead of the private key. There are several ways to provide authentication/integrity by using the secret key. The main two are Hash-Based Message Authentication Codes (HMAC), and Encryption-Based Message Authentication Codes. In HMAC, a strong hash function algorithm, such as MD5 or SHA1, is used to create a hashing value over the data and the embedded secret key. Different HMAC algorithms use different embedding strategies. At the receiver side, the same hash function is applied on the concatenated data and key. The authenticity and integrity of the received data is assured by matching the hashing value of the received message with the recalculated hashing value.

In Encryption-Based Message Authentication Codes, a combination of hashing and encryption is used. A hashing value is calculated over the data using the hashing algorithm. The encryption algorithm is used to encrypt the hashing value using the secret key. At the receiver side, the hashing value is recalculated, and using the secret key, the sent hashing value is decrypted. The authenticity and integrity of the received data is assured by matching the recalculated hashing value with the decrypted hashing value.

A more conservative approach to building a MAC from a Modification Detection Code (MDC) is to arrange that the MAC compression function itself depend on secret key k, implying that k is involved in all intervening iterations. This provides an additional protection in the case that weaknesses of the underlying hash function becomes known. Algorithm MD5-MAC is such a technique. MD5-MAC is obtained from MD5 by replacing the four 32-bit IV's of MD5 by the secret key K [1]. A New Media Access Code Algorithm (NMACA)-MD5 technique has been proposed that uses the key K to determine the MD5 algorithmic steps, rather than using the key as the initial chaining values to the algorithm. This K is used to determine the access order for message words and to determine the shift amounts in the distinct rounds. This novel technique is described in detail in: “K. S. Alghathbar and A. M. Hafez, “The Use of NMACA Approach in Building a Secure Message Authentication Code,” International Journal of Education and Information Technologies, Issue 3, Volume 3 (2009), which is hereby incorporated in its entirety by reference.

In contrast to the above, systems and methods for code-based hashing for message authentication algorithms provide a new direction of message authentication code (MAC) techniques for message authentication. Instead of using a hash function for generating the message authentication code, the systems and methods utilize message itself as a program code to generate the MAC. The MAC secret key is used to build hash functions using language interpreters and by defining the order for accessing source words and defining the number of bit positions for left shifts in the compression function. This provides a hash function that is dynamic (not fixed) and depends on the code being hashed. More particularly, the systems and methods use a secret key K of length 192 to form a MAC algorithm. Rather than using the secret key K as the initial chaining values to the algorithm, K is used to determine the access order for message words and the order of performing the hash function stages. The systems and methods utilize the 192 bit key K to determine the language interpreter and the shift amounts in the distinct rounds. These and other aspects of the systems and methods for code-based hashing for message authentication algorithms are now described in greater detail.

### An Exemplary Environment

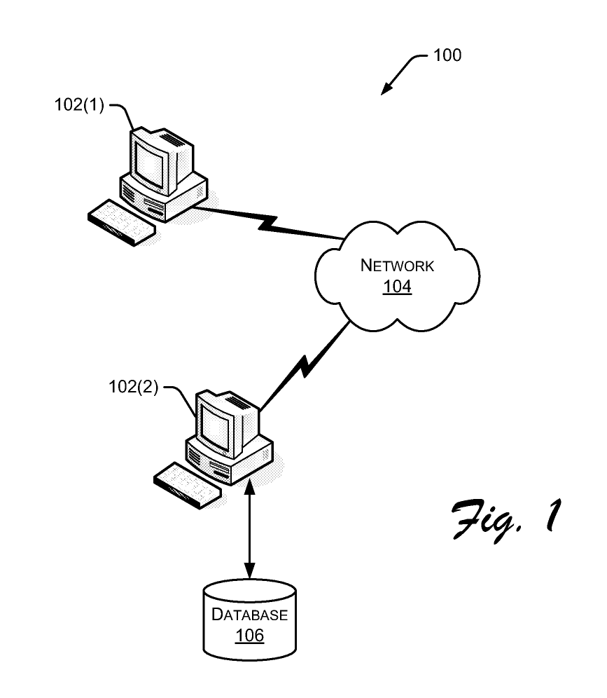

FIG. 1 illustrates an example environment 100 capable of implementing the systems and methods described herein, according to one embodiment. In this example, environment 100 includes two computing systems 102(1) and 102(2) that communicate with one another via a data communication network 104. Computing systems 102(1) and 102(2) represent any type of computing device, such as a server, workstation, laptop computer, tablet computer, handheld computing device, smart phone, personal digital assistant, game console, set top box, and the like. As discussed herein, and in one embodiment, computing systems 102(1) and 102(2) access data from digital archives (e.g., database 106) and/or are configured to send and receive messages to one another. Computing systems 102(1) and 102(2) also perform additional functions such as executing computer programs to implement the systems and methods described herein to ensure authenticity and integrity of received messages and/or data stored in a digital archive such as a database 106, and so forth.

Data communication network 106 represents any type of network, such as a local area network (LAN), wide area network (WAN), or the Internet. In particular embodiments, data communication network 106 is a combination of multiple networks communicating data using various protocols across any communication medium.

Although two computing systems (102) are shown in FIG. 1, alternate embodiments may include any number of computing systems coupled together via any number of data communication networks 106 and/or communication links.

### An Exemplary Computing Device

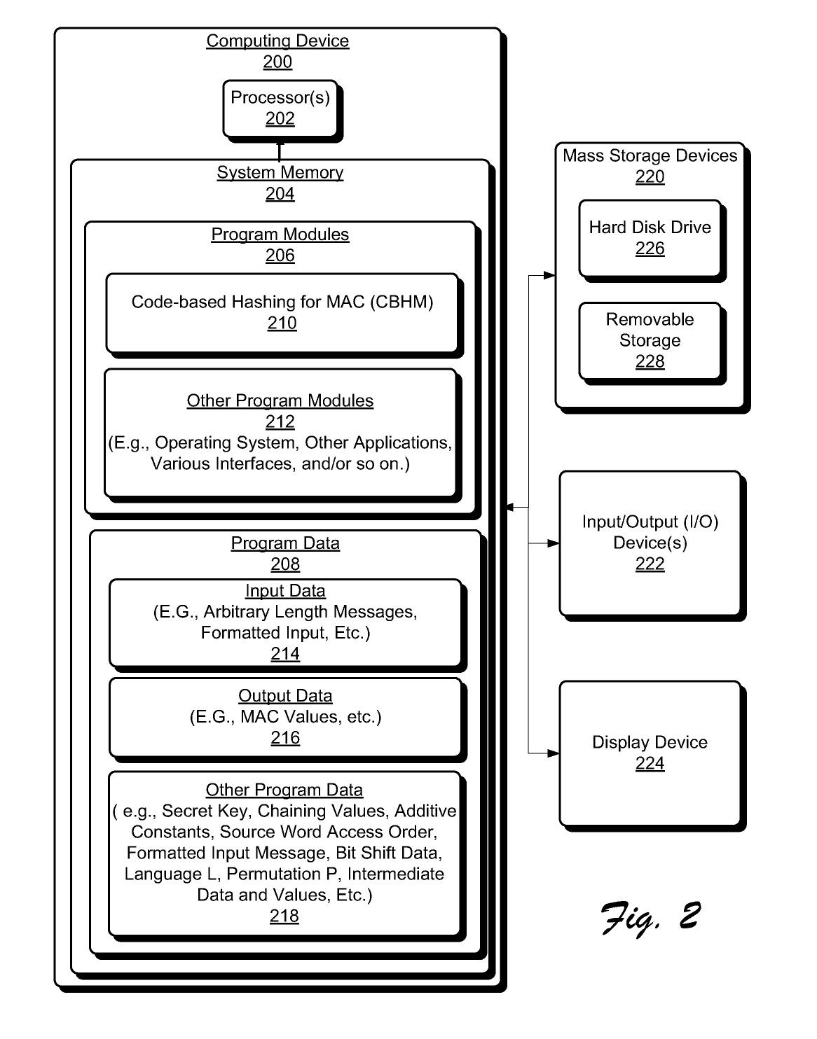

FIG. 2 shows a block diagram illustrating an exemplary computing device 200, according to one embodiment. Computing device 200 may be used to perform various procedures, such as those discussed herein that are associated with code-based hashing for message authentication algorithms. Computing device 200 represents any one or more of computing devices 102(a) or 102(b) of FIG. 1. Accordingly, computing device 200 can function as a server, a client, a worker node, or any other computing entity. Computing device 200 can be any of a wide variety of computing devices, such as a desktop computer, a notebook computer, a server computer, a handheld computer, and the like.

Computing device 200 includes one or more processor(s) 202, a tangible computer readable memory 204 (memory), program modules/computer-program instructions 206, and program data 208. Processor(s) 202 may also include various types of computer-readable media, such as cache memory. Memory 204 includes various computer-readable media, such as volatile memory (e.g., random access memory (RAM)) 714 and/or nonvolatile memory (e.g., read-only memory (ROM) 716). Memory device(s) 704 may also include rewritable ROM, such as Flash memory.

Computer program modules 204 include, for example, code-based hashing module for MAC (CBHM) module 210, and other program modules 212. CBHM module 210 includes computer-program instructions executable by the processor(s) 202 to perform procedures associated with code-based hashing for message authentication algorithms. Other program modules 212 include, for example, an operating system, other applications, and various interfaces that allow computing device 200 to interact with other systems, devices, or computing environments. Example such interface(s) include any number of different network interfaces, such as interfaces to local area networks (LANs), wide area networks (WANs), wireless networks, and the Internet. Other interfaces include user interface and peripheral device interface. Program data 208 includes, for example, input data 214 such as arbitrary length messages for processing by one or more respective program modules 206, output data 216 such as hashes, MAC values, and other program data 218 such as a secret key, intermediate data and values, etc.

Computer 200 is also operatively coupled to one or more mass storage devices 220, one or more I/O device(s) 222, and a display device 224. Mass storage device(s) 220 include various computer readable media, such as magnetic tapes, magnetic disks, optical disks, solid state memory (e.g., Flash memory), and so forth. As shown in FIG. 2, a particular mass storage device is a hard disk drive 226. Various drives may also be included in mass storage device(s) 220 to enable reading from and/or writing to the various computer readable media. Mass storage device(s) 708 include removable media 228 and/or non-removable media.

Various I/O devices 222 allow data and/or other information to be input to or retrieved from computing device 200. Example I/O device(s) include cursor control devices, keyboards, keypads, microphones, monitors or other display devices, speakers, printers, network interface cards, modems, lenses, CCDs or other image capture devices, and the like. Display device 224 includes any type of device capable of displaying information to one or more users of computing device 700. Examples of display device 224 include a monitor, display terminal, video projection device, and the like.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### Exemplary Logic Dataflow

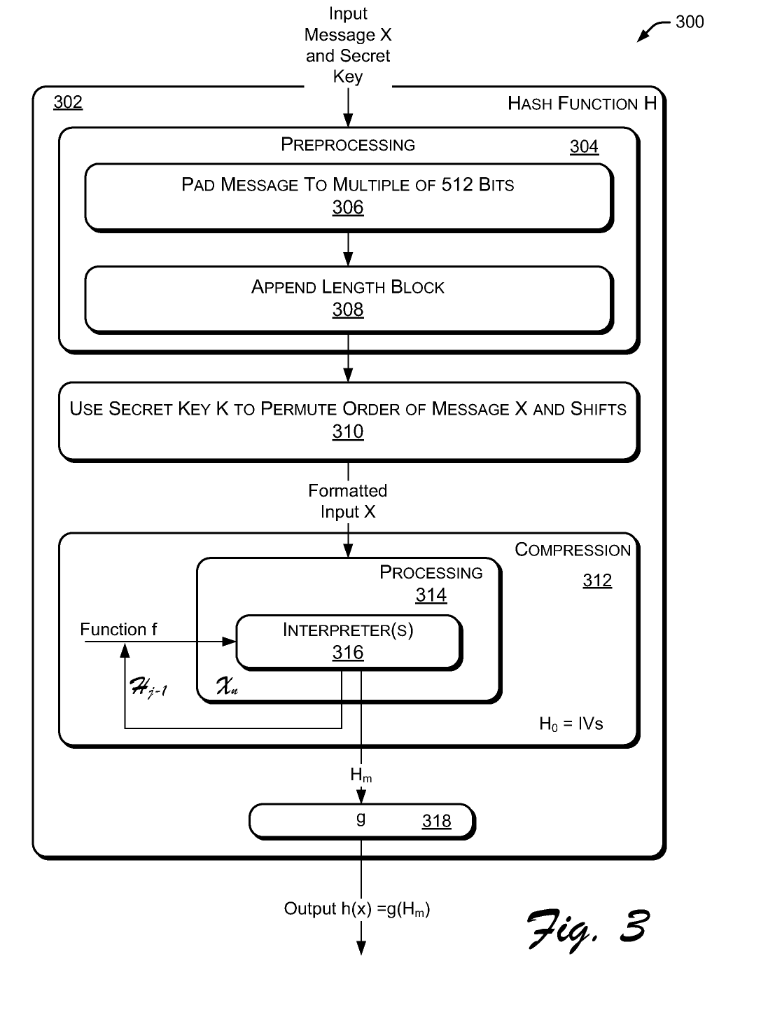

FIG. 3 is a block diagram illustrating exemplary logic and data flow 300 for code-based hashing for Message authentication, according to one embodiment. In particular, the block diagram illustrates exemplary aspects of a hash function 302 (“H”) portion of code-based hashing module 210 of FIG. 2. In this implementation, hash function 302 uses a 192-bit secret key. Such a secret key is shown as a respective portion of “other program data” 218 of FIG. 2. Hash function 302, as described in greater detail below, utilizes a novel language and an interpreter induced from an arbitrary length input message X 214 (please see FIG. 2), and wherein the secret key is used to permute the input message X (specify the order of using message words). The input message will be used as a source code interpreted and executed by the language L to generate a 128-bit hash code of X (i.e., a message authentication code).

Before starting the actual code-based hashing procedure, the following operations are implemented:
(a) Define four 32-bit initial chaining values (IVs). In this implementation, the same initial chaining values used in MD5 are utilized, wherein h1=0x67452301, h2=0xefcdab89, h3=0x98badcfe, h4=0x10325476.
(b) Four additional sets of values are calculated:
   A set of y values used in performing the shifts of the input message X.
   A set of z values used in defining the order of accessing the input message X based on secret key K.
   A set of s values used in left shifts (rotates) based on secret key K.
   A set of values Pₛ used in choosing the language operation codes based on secret key K.

As a last step in preprocessing, extra bits are added to the input message X to make its length a multiple of 512. Assume, we need m bits to adjust the length of X. 64 bits are reserved for appending the length of X (b mod 2⁶⁴ bits) at the end of the adjusted message. The other r (m-64) consists of single bit of “1” and r−1 bits of “0's”. The actual processing is carried by using the IV's (H₁; H₂; H₃; H₄) as initial values of A, B, C and D. Each 512 block of X is ordered using Pₛ, and each byte of the permuted X is used as operation applied on A, B, C, and D. The procedure is carried on, and the final values of A, B, C, and D are concatenated to represent the MAC value. An exemplary such language L is shown in TABLE 1 below, and as a respective portion of “other program data” 218 of FIG. 2.

Referring to FIG. 3, input data, comprising a message X of arbitrary length (≧0) and a 192-bit secret key is received by hash function 302. In this particular implementation, preprocessing logic 304 defines a set of initial values and operation codes/operational interpretation of hashing language L. For example, preprocessing logic 304 defines four 32-bit initial chaining values (IVs) and a set of additive 32-bit constants. In one exemplary implementation, the four 32-bit initial chaining values are defined as follows: h1=0x67452301; h2=0xefcdab89; h3=0x98badcfe; and, h4=0x10325476. In this implementation, the additive 32-bit constants are defined as follows: y[j]=first 32 bits of binary value abs(sin(j+1)), 0≦j≦563, where j is in radians and “abs” denotes absolute value.

Block 306 of the preprocessing logic 304 pads message X such that the bit length of message X is a multiple of 512. In one implementation, such message padding is accomplished by appending a single 1-bit, then append r−1 (≧0) 0-bits for the smallest r resulting in a bit length 64 less than a multiple of 512 (64 bits are reserved for the length of the input message).

At block 308, the 64-bit representation of b mod 2⁶⁴ are appended to one another as two 32-bit words with least significant word first. Let m be the number of 512-bit blocks in the resulting string (b+r+64=512 m=32×16m). At block 310, the secret key (a respective portion of input data) is used to permute the access order of the input message's words. In one exemplary implementation, the order for accessing source words determined in view of the input secret key K is as follows:

z[0::15]=[Permutation P_{O} of the 1st 16 bits of K, P₀: {0, 1, . . . , 15}]

z[16::31]=[Permutation P₁ of the 2nd 16 bits of K, P₀: {16, 17, . . . , 31}]

z[32::47]=[Permutation P₂ of the 3rd 16 bits of K, P₀: {32, 33, . . . , 47}

z[48::63]=[Permutation P₃ of the 4th 16 bits of K, P₀: {48, 49, . . . , 63}]

Here, “z” is used to define the order of accessing the source using the first 64 bits of secret key K.

Operations of block 310 further define the number of bit positions for left shifts (rotates) based on respective portions of the secret key K and operations of language L. In this exemplary implementation, the number of bit positions for left shifts is defined as follows:
s[0::63]=[Permutation P_{S} of the second 64 bits of K, P_{S}: {0, 1, . . . , 63}→{Oᵢ|0≦Oᵢ≦63}.

Operations of block 310 further define a permutation P_{L} from language L={set of operations, e.g., as shown below in TABLE 1}. As shown, each operation of language L is associated with a particular operation code “Oᵢ” such that Permutation P_{L} is defined as the last 64 bits of K, P_{L}: {0, 1, . . . , 63}→{Oi|0≦Oi≦63}. In this exemplary implementation, a 192 operation language is defined by repeating the permutation of the 64 operations (e.g., as shown in TABLE 1), four times as described below in paragraph 0. The operations in TABLE 1 describe the Assembly language L of some machine M.

TABLE 1
Exemplary Operation Code/Operation Interpretation of Language L

| Operation | |
|---|---|
| Code | Operation |
| 0 | B ⊕ CD |
| 1 | B ⊕ C D̅ |
| 2 | B ⊕ C̅D |
| 3 | B ⊕ C̅D̅ |
| 4 | B̅ ⊕ CD |
| 5 | B̅ ⊕ C D̅ |
| 6 | B̅ ⊕ C̅D |
| 7 | B̅ ⊕ C̅D̅ |
| 8 | B ⊕ C ⊕ D |
| 9 | B ⊕ C ⊕ D̅ |
| 10 | B ⊕ C̅ ⊕ D |
| 11 | B ⊕ C̅ ⊕ D̅ |
| 12 | B̅ ⊕ C ⊕ D |
| 13 | B̅ ⊕ C ⊕ D̅ |
| 14 | B̅ ⊕ C̅ ⊕ D |
| 15 | B̅ ⊕ C̅ ⊕ D̅ |
| 16 | BC [symbol] BD |
| 17 | BC [symbol] B D̅ |
| 18 | BC [symbol] B̅D |
| 19 | BC [symbol] B̅D̅ |
| 20 | B C̅ [symbol] B̅D̅ |
| 21 | B C̅ [symbol] B D̅ |
| 22 | B C̅ [symbol] B̅D |
| 23 | B C̅ [symbol] BD |
| 24 | B̅C [symbol] B̅D̅ |
| 25 | B̅C [symbol] B D̅ |
| 26 | B̅C [symbol] B̅D |
| 27 | B̅C [symbol] BD |
| 28 | B̅C̅ [symbol] B̅D̅ |
| 29 | B̅C̅ [symbol] B̅D |
| 30 | B̅C̅ [symbol] B D̅ |
| 31 | B̅C̅ [symbol] BD |
| 32 | B ⊕ C ⊕ CD |
| 33 | B ⊕ C ⊕ C D̅ |
| 34 | B ⊕ C ⊕ C̅D |
| 35 | B ⊕ C ⊕ C̅D̅ |
| 36 | B ⊕ D ⊕ CD |
| 37 | B ⊕ D ⊕ C D̅ |
| 38 | B ⊕ D ⊕ C̅D |
| 39 | B ⊕ D ⊕ C̅D̅ |
| 40 | B ⊕ C ⊕ BD |
| 41 | B ⊕ C ⊕ B D̅ |
| 42 | B ⊕ C ⊕ B̅D |
| 43 | B ⊕ C ⊕ B̅D̅ |
| 44 | D ⊕ C ⊕ BD |
| 45 | D ⊕ C ⊕ B D̅ |
| 46 | D ⊕ C ⊕ B̅D |
| 47 | D ⊕ C ⊕ B̅D̅ |
| 48 | BC [symbol] CD [symbol] DB |
| 49 | B̅C [symbol] CD [symbol] DB |
| 50 | B C̅ [symbol] CD [symbol] DB |
| 51 | BC [symbol] C̅D [symbol] DB |
| 52 | BC [symbol] C D̅ [symbol] DB |
| 53 | BC [symbol] CD [symbol] D̅B |
| 54 | BC [symbol] CD [symbol] D B̅ |
| 55 | B̅C [symbol] C̅D [symbol] DB |
| 56 | BC [symbol] C̅D [symbol] D B̅ |
| 57 | B C̅ [symbol] CD [symbol] D B̅ |
| 58 | B C̅ [symbol] C D̅ [symbol] DB |
| 59 | BC [symbol] C̅D̅ [symbol] DB |
| 60 | B C̅ [symbol] C D̅ [symbol] D B̅ |
| 61 | B C̅ [symbol] C D̅ [symbol] D̅B̅ |
| 62 | B C̅ [symbol] C̅D̅ [symbol] D̅B̅ |
| 63 | B̅C̅ [symbol] C̅D̅ [symbol] D̅B̅ |

For example, B⊕CD is the “XOR” operation on B and CD, and CD is the “AND” operation on C and D, and B C̅ V BD is the “OR” operation on B C̅ and BD, B C̅ is the “AND” operation on B and the complement of C.

At this point, formatted input (shown as a respective part of input date 214 of FIG. 2) is input into compression logic 312. In this particular implementation, formatted input, for example, includes 16 m 32-bit words: x0 x1::: x16m−1. Compression logic 312 initializes variables H1, H2, H3, and H4 with the initial chaining values h1, h2, h3, and h4 (i.e., H1; H2; H3; H4←h1; h2; h3; h4). Processing portion 314 of compression logic 312 includes interpreter portion 316 which initializes working variables: (A;B;C;D)←(H1; H2; H3; H4), and for each i from 0 to m−1, copies the i^{th} block of sixteen 32-bit words into temporary storage: e.g., X[j]=x₁₆ᵢ₊ⱼ; 0≦j≦15. These then are processed in four 16-step rounds as described below before updating the chaining variables H1 through H4. Each byte Rⱼ, 0≦j≦63, is a byte in the 512 bit-block. Rᵢ is defined as an operation code from the language defined by P_{L}. Here, i is used as a parameter. Rᵢ is an assembly language operation applied on some parameters, and is used in calculated t.

1. (Round 1) For j from 0 to 15 do the following:

t←(A+Rj(B;C;D)+X[z[j]]+y[j]),(A;B;C;D)←(D;t←s[j];B;C).

2. (Round 2) For j from 16 to 31 do the following:

t←(A+Rj(B;C;D)+X[z[j]]+y[j]),(A;B;C;D)←(D;t←s[j];B;C).

3. (Round 3) For j from 32 to 47 do the following:

t←(A+Rj(B;C;D)+X[z[j]]+y[j]),(A;B;C;D)←(D;t←s[j];B;C).

4. (Round 4) For j from 48 to 63 do the following:

t←(A+Rj(B;C;D)+X[z[j]]+y[j]),(A;B;C;D)←(D;t←s[j];B;C).

<Please indicate where this

5. (Update chaining values) (H1;H2;H3;H4) (H1+A;H2+B;H3+C;H4+D).

As shown in FIG. 3, the hash function H 302 outputs the final MAC at 318, which concatenates H1∥H2∥H3∥H4 with first and last bytes the low-and high-order bytes of H1, H4, respectively.

### An Exemplary Code-Based Hashing Technique

In the following example, we show detailed steps of how the code-based hashing technique works. Assume the input message is X=“Center Of Excellence”, and secret key is K=“CenterOfExcellenceAndInf”. The following steps are applied:
The ASCII codes of X characters are
43 65 6E 74 65 72 20 4F 66 20 45 78 63 65 6C 65 6E 63 65
With length 152 bits
To make the message of length 512 bits, we need to add 360 bits. 296 bits embedded bits and 64 length bits. The embedded bits are:
80 00 00 00 00 00 00 00 00 00 00 00 00 00 00 00 00 00 00 00 00 00 00 00 00 00 00 00 00 00 00 00 00 00 00 00 00,
and length are
98 00 00 00 00 00 00 00
z values
4 8 0 1 3 6 13 11 7 12 9 2 5 10 14 15 6 13 11 7 14 12 9 3 8 15 0 10 4 1 2 5 6 12 9 2 5 10 7 11 8 14 13 15 3 4 0 1 4 9 3 7 15 14 13 11 6 12 10 5 8 0 1 2
s values
4 8 1 2 5 10 6 11 7 15 14 12 9 0 3 13 6 12 8 1 37 13 11 9 14 10 2 5 15 0 4 6 13 11 7 12 8 1 3 9 14 15 10 0 2 4 5 6 12 9 2 5 10 7 11 8 13 14 15 0 1 3 4
Permutation ordering
6 12 8 1 3 7 13 11 9 14 10 2 5 15 0 4 20 24 16 17 18 19 21 27 22 29 28 23 30 31 25 26 38 44 41 34 36 40 33 35 37 42 39 43 45 46 47 32 54 61 59 55 62 60 57 51 56 63 58 52 48 49 50 53 6 12 8 1 3 7 13 11 9 14 10 2 5 15 0 4 20 24 16 17 18 19 21 27 22 29 28 23 30 31 25 26 38 44 41 34 36 40 33 35 37 42 39 43 45 46 47 32 54 61 59 55 62 60 57 51 56 63 58 52 48 49 50 53 6 12 8 1 37 13 11 9 14 10 2 5 15 0 4 20 24 16 17 18 19 21 27 22 29 28 23 30 31 25 26 38 44 41 34 36 40 33 35 37 42 39 43 45 46 47 32 54 61 59 55 62 60 57 51 56 63 58 52 48 49 50 53 6 12 8 1 3 7 13 11 9 14 10 2 5 15 0 4 20 24 16 17 18 19 21 27 22 29 28 23 30 31 25 26 38 44 41 34 36 40 33 35 37 42 39 43 45 46 47 32 54 61 59 55 62 60 57 51 56 63 58 52 48 49 50 53
Message to be Processed (first byte is the least significant byte)

| Before Ordering | After Ordering |
|---|---|
| 746E6543 | 8065636E |
| 4F207265 | 00000000 |
| 78452066 | 746E6543 |
| 656C6563 | 4F207265 |
| 8065636E | 656C6563 |
| 00000000 | 00000000 |
| 00000000 | 00000000 |
| 00000000 | 00000000 |
| 00000000 | 00000000 |
| 00000000 | 00000000 |
| 00000000 | 00000000 |
| 00000000 | 78452066 |
| 00000000 | 00000000 |
| 00000000 | 00000000 |
| 00000098 | 00000098 |
| 00000000 | 00000000 |

Generate Code-Based MAC

| Step | R | A | B | C | D |
|---|---|---|---|---|---|
| 0 | 0 | 67452301 | EFCDAB89 | 98BADCFE | 10325476 |
| 1 | 1 | 55728A0B | EFCDAB89 | 98BADCFE | 10325476 |
| 2 | 1 | 55728A0B | EFCDAB89 | 98BADCFE | DD27DEAE |
| 3 | 1 | 55728A0B | EFCDAB89 | B519888B | DD27DEAE |
| 4 | 1 | 55728A0B | 623B11CF | B519888B | DD27DEAE |
| 5 | 1 | 4DCC2EB7 | 623B11CF | B519888B | DD27DEAE |
| 6 | 1 | 4DCC2EB7 | 623B11CF | B519888B | 3E1A6C80 |
| 7 | 1 | 4DCC2EB7 | 623B11CF | 152915F6 | 3E1A6C80 |
| 8 | 1 | 4DCC2EB7 | 1893E029 | 152915F6 | 3E1A6C80 |
| 9 | 1 | 0CE9FC8A | 1893E029 | 152915F6 | 3E1A6C80 |
| 10 | 1 | 0CE9FC8A | 1893E029 | 152915F6 | 3D56EFAE |
| 11 | 1 | 0CE9FC8A | 1893E029 | 9E81FD63 | 3D56EFAE |
| 12 | 1 | 0CE9FC8A | 9BE170D4 | 9E81FD63 | 3D56EFAE |
| 13 | 1 | FD1B400D | 9BE170D4 | 9E81FD63 | 3D56EFAE |
| 14 | 1 | FD1B400D | 9BE170D4 | 9E81FD63 | 33061226 |
| 15 | 1 | FD1B400D | 9BE170D4 | 92C1B64A | 33061226 |
| 16 | 1 | FD1B400D | 166CD935 | 92C1B64A | 33061226 |
| 17 | 2 | 53BF39AC | 166CD935 | 92C1B64A | 33061226 |
| 18 | 2 | 53BF39AC | 166CD935 | 92C1B64A | EC82D535 |
| 19 | 2 | 53BF39AC | 166CD935 | B836601D | EC82D535 |
| 20 | 2 | 53BF39AC | 00A7F57A | B836601D | EC82D535 |
| 21 | 2 | 5A426E04 | 00A7F57A | B836601D | EC82D535 |
| 22 | 2 | 5A426E04 | 00A7F57A | B836601D | 9480310A |
| 23 | 2 | 5A426E04 | 00A7F57A | E945F0A0 | 9480310A |
| 24 | 2 | 5A426E04 | 8ADADACB | E945F0A0 | 9480310A |
| 25 | 2 | 1D9B2C86 | 8ADADACB | E945F0A0 | 9480310A |
| 26 | 2 | 1D9B2C86 | 8ADADACB | E945F0A0 | 68A9A34C |
| 27 | 2 | 1D9B2C86 | 8ADADACB | 2EDE2B18 | 68A9A34C |
| 28 | 2 | 1D9B2C86 | 6195CD24 | 2EDE2B18 | 68A9A34C |
| 29 | 2 | 1AEED278 | 6195CD24 | 2EDE2B18 | 68A9A34C |
| 30 | 2 | 1AEED278 | 6195CD24 | 2EDE2B18 | 46607AF2 |
| 31 | 2 | 1AEED278 | 6195CD24 | B53C3184 | 46607AF2 |
| 32 | 2 | 1AEED278 | C612B398 | B53C3184 | 46607AF2 |
| 33 | 3 | 84F002DD | C612B398 | B53C3184 | 46607AF2 |
| 34 | 3 | 84F002DD | C612B398 | B53C3184 | 52C325DB |
| 35 | 3 | 84F002DD | C612B398 | 85DB920F | 52C325DB |
| 36 | 3 | 84F002DD | 1C429097 | 85DB920F | 52C325DB |
| 37 | 3 | A61654A4 | 1C429097 | 85DB920F | 52C325DB |
| 38 | 3 | A61654A4 | 1C429097 | 85DB920F | B8B52C1B |
| 39 | 3 | A61654A4 | 1C429097 | 6FF78EE8 | B8B52C1B |
| 40 | 3 | A61654A4 | F85B04BB | 6FF78EE8 | B8B52C1B |
| 41 | 3 | A5B88787 | F85B04BB | 6FF78EE8 | B8B52C1B |
| 42 | 3 | A5B88787 | F85B04BB | 6FF78EE8 | 374BC7D5 |
| 43 | 3 | A5B88787 | F85B04BB | 330BB2C3 | 374BC7D5 |
| 44 | 3 | A5B88787 | E54945C8 | 330BB2C3 | 374BC7D5 |
| 45 | 3 | 83CD9CAB | E54945C8 | 330BB2C3 | 374BC7D5 |
| 46 | 3 | 83CD9CAB | E54945C8 | 330BB2C3 | B52E68F1 |
| 47 | 3 | 83CD9CAB | E54945C8 | CD2ED309 | B52E68F1 |
| 48 | 3 | 83CD9CAB | 0DF97844 | CD2ED309 | B52E68F1 |
| 49 | 4 | A6ADE272 | 0DF97844 | CD2ED309 | B52E68F1 |
| 50 | 4 | A6ADE272 | 0DF97844 | CD2ED309 | 871EAB8C |
| 51 | 4 | A6ADE272 | 0DF97844 | 4C6F8049 | 871EAB8C |
| 52 | 4 | A6ADE272 | FFEAAAE4 | 4C6F8049 | 871EAB8C |
| 53 | 4 | 8F4EB1E2 | FFEAAAE4 | 4C6F8049 | 871EAB8C |
| 54 | 4 | 8F4EB1E2 | FFEAAAE4 | 4C6F8049 | 0E677BFD |
| 55 | 4 | 8F4EB1E2 | FFEAAAE4 | DA68E263 | 0E677BFD |
| 56 | 4 | 8F4EB1E2 | 4F9B7BB3 | DA68E263 | 0E677BFD |
| 57 | 4 | 3DE588B7 | 4F9B7BB3 | DA68E263 | 0E677BFD |
| 58 | 4 | 3DE588B7 | 4F9B7BB3 | DA68E263 | 29223498 |
| 59 | 4 | 3DE588B7 | 4F9B7BB3 | A099B924 | 29223498 |
| 60 | 4 | 3DE588B7 | DEF4E9EA | A099B924 | 29223498 |
| 61 | 4 | 3C5703B0 | DEF4E9EA | A099B924 | 29223498 |
| 62 | 4 | 3C5703B0 | DEF4E9EA | A099B924 | D05529E1 |
| 63 | 4 | 3C5703B0 | DEF4E9EA | 9433803E | D05529E1 |
| 64 | 4 | 3C5703B0 | B8D734FF | 9433803E | D05529E1 |

Update chaining values (H1;H2;H3;H4)←(H1+A;H2+B;H3+C;H4+D).

| | | | |
|---|---|---|---|
| A39C26B1 | A8A4E088 | 2CEE5D3C | E0877E57 |

Put the output in order

| | | | |
|---|---|---|---|
| B1269CA3 | 88E0A4A8 | 3C5DEE2C | 577E87E0 |

Output Code-Based MAC
B1269CA388E0A4A83C5DEE2C577E87E0

In view of the above, code-based hashing for message authentication, as provided by hash function H 302, uses a secret key K to build hash functions using language interpreters 316 and by defining the order for accessing source words associated with an input message X, and defining the number of bit positions for left shifts in the correspond function's compression function. This provides for code-based hashing for message authentication code generation that is dynamic (not fixed).

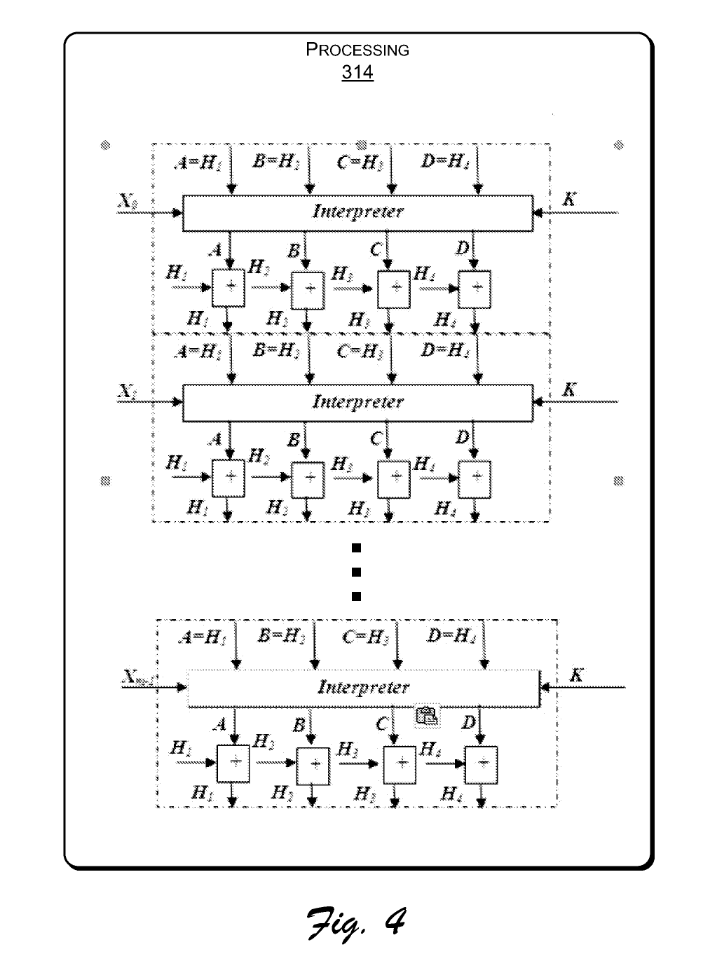

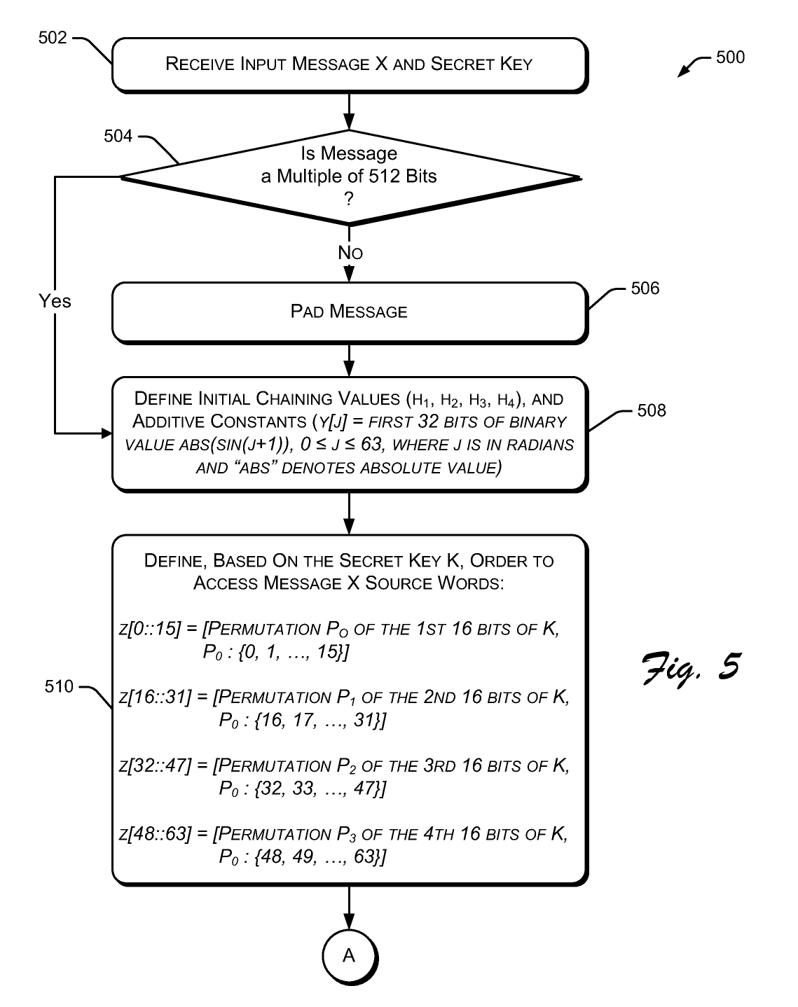

FIG. 4 shows exemplary data flow of the processing and interpreter portions of the compression logic for code-based hashing for message authentication, according to one embodiment. Aspects of this figure are discussed in detail above with respect to FIG. 3 and below with respect to FIG. 5 through FIG. 7.

### Exemplary Procedure

FIG. 5 is a flowchart showing an exemplary procedure for code message authentication algorithms, according to one embodiment. At block 502, an arbitrary length input message X and a secret key K is received. In one implementation, this input data (e.g., a respective portion of input data 214) is received by (CBHM) program module 210 of FIG. 2. In this implementation, the secret key is a 192-bit key. In a different implementation, the size of the secret key can be a different bit size and the corresponding algorithms pertaining to use of specific ones of the secret key bits (e.g., to define order to access to message source words, etc.) is modified accordingly to take into account the different bit size.

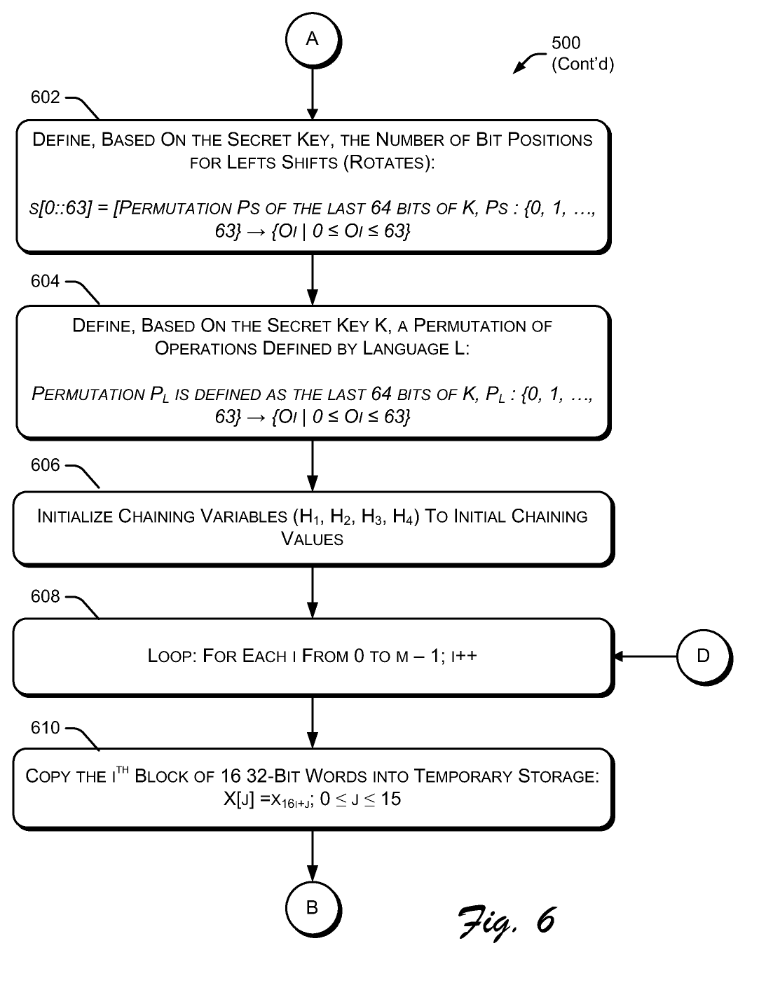

Operations of block 504 determine whether the input message X is a multiple of a particular target bit size such as 512 bits. If the input message is not a multiple of the target bit size, the procedure 500 continues at block 506. Otherwise, the procedure's operations continue at block 508, as described below. At block 506, the input message X is padded to obtain the desired target message bit size (e.g., a multiple of 512 bits). At block 508, initial 32-bit chaining values (H₁, H₂, H₃, and H₄) and additive 32-bit constants are defined (y[j]=first 32 bits of binary value abs(sin(j+1)), 0≦j≦63, where j is in radians and “abs” denotes absolute value). At block 510, the procedure defines the order to access the input message's respective source words (z[0::15], z[16::31], z[32::47], and z[48::63]) as a function of the input data secret key K bits. Procedure 500 continues at FIG. 6 as indicated by on page reference “A.”

FIG. 6 is a flowchart that shows further exemplary aspects of the exemplary procedure of FIG. 5 for code-based hashing for message authentication algorithms, according to one embodiment. At block 602, the number of bit positions for left shifts (rotates) is defined (i.e., s[0::63]) as a function of the second 64 bits of the input secret key K. Operations of block 604 define permutation (P_{L}) of operations defined in the language L. In this exemplary implementation, the permutation is defined using the last 64 bits of the secret key K. An exemplary set of operations and corresponding operation codes for language L are shown in TABLE 1, above. Operations of block 606 initialize the variables for chaining (h₁, h₂, h₃, and h₄) with the initial chaining values assigned at block 508 of FIG. 5.

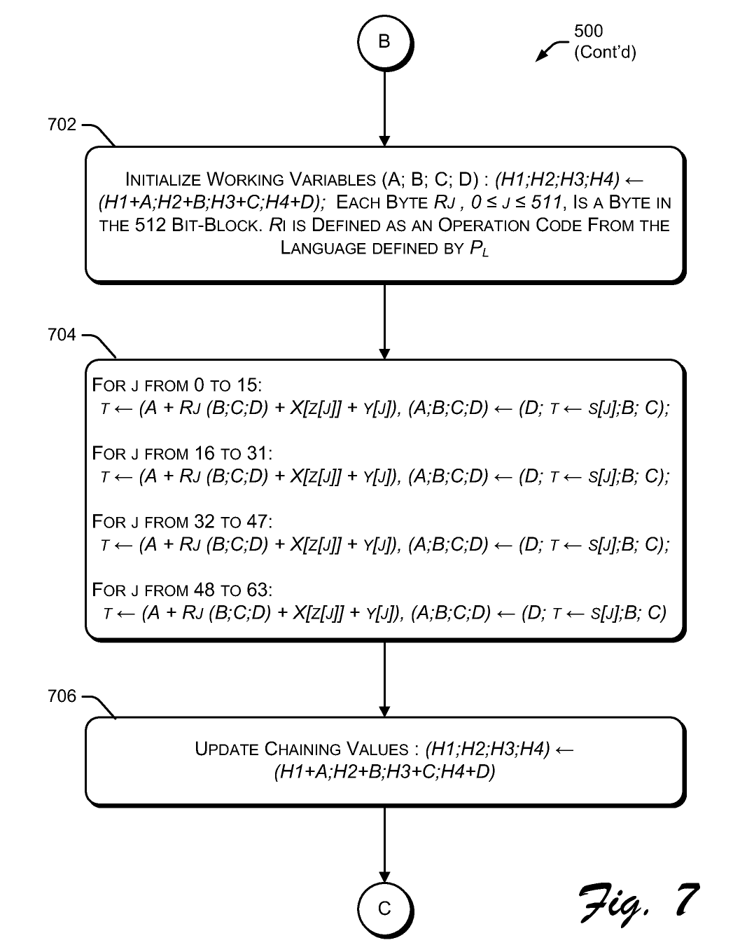

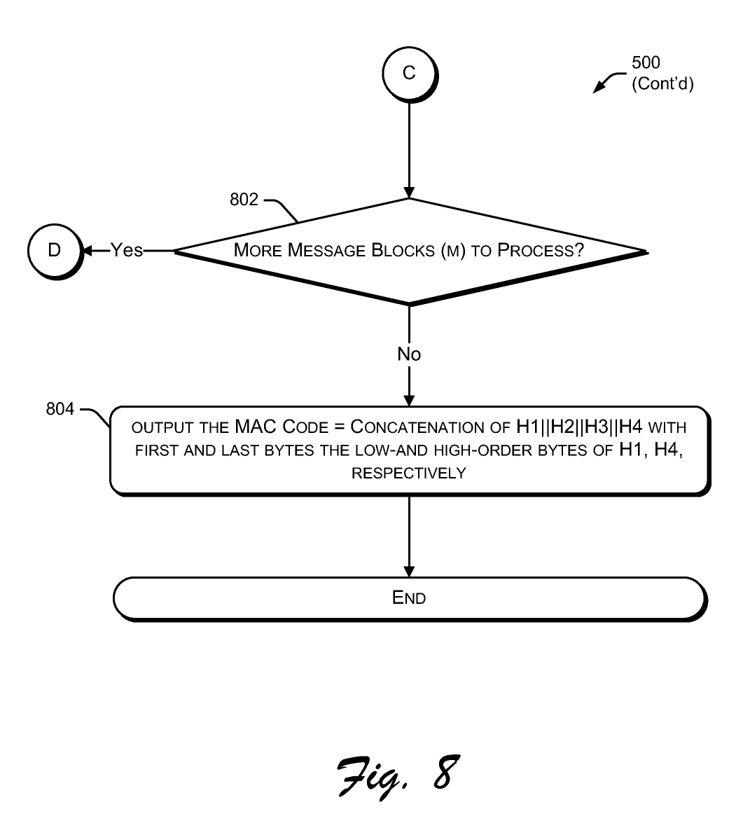

At this point, the operations of block 608 loop to process each block of the formatted input message (e.g., 16 m 32-bit words; x₀, x₁ . . . x₁₆ₘ₋₁). In this implementation, each block is 512 bits. Such a formatted input message (formatted message) is shown as respective portion of other program data 218 of FIG. 2. This block processing loop comprises, for example, the operations of blocks 608 and 610 of FIG. 6, the operations of blocks 702 through 706 of FIG. 7, and the operations 802 and 804 of FIG. 8, each of which are now described in greater detail. Referring to FIG. 6, operations of block 610, copy the i^{th} block of sixteen 32-bit words into temporary storage for subsequent processing. Operations of procedure 500 continue in FIG. 7, as illustrated in FIG. 6 on page reference “B.”

FIG. 7 is a flowchart that shows further exemplary aspects of the exemplary procedure of FIGS. 5 and 6 for code-based hashing for message authentication algorithms, according to one embodiment. Operations of block 702 initialize working variables for code-based hashing to generate a resulting message authentication code value. These particular working variables are utilized in subsequent operations of this procedure. Operations of block 704 implement respective portions of code-based hashing to generate a MAC value (please see interpreters 316 of FIG. 3). An exemplary such MAC value is shown as a respective portion of output data 216 of FIG. 2. These looped operations implement a 192 operation-language by repeating the permutation of TABLE 1 four times. Operations of block 706 update the chaining values. Operations for procedure 500 continue in FIG. 8 as illustrated by on page reference “C.”

FIG. 8 is a flowchart that shows further exemplary aspects of the exemplary procedure of FIGS. 5 through 7 for code-based hashing for message authentication algorithms, according to one embodiment. Operations of block 802 determine whether are more message blocks m of the formatted input message to process. If so, operations of procedure 500 continue in FIG. 6 at block 608, as indicated by on page reference “D.” However, if all blocks m of the formatted input message have been processed using the operations initiated with the loop at block 608 of FIG. 6, the procedure continues at block 804. Operations of block 804 generate the final MAC value for the input message X by concatenating the working chaining value variables (H1|H2|H3|H4) with first and last bytes, the low and high order bytes of H1 and H4, respectively.

### CONCLUSION

Although the systems and methods for code-based hashing for message authentication algorithms have been described in language specific to structural features and/or methodological operations or actions, it is understood that the implementations defined in the appended claims are not necessarily limited to the specific features or actions described. Rather, the specific features and operations of code-based hashing for message authentication algorithms are disclosed as exemplary forms of implementing the claimed subject matter.

1. A computer-implemented method comprising:
receiving a message and a secret key;
building, based on respective portions of the secret key and a language interpreter, a hash function; and
hashing, using the hash function, a formatted message to generate a message authentication code (MAC) for authentication of the message.

2. The computer-implemented method of claim 1, wherein the secret key is a 192-bit secret key.

3. The computer-implemented method of claim 1, wherein building the hash function further comprises:
identifying, based on respective portions of the secret key, a source word access order/priority to access source words of the formatted message;
determining, based on respective portions of the secret key and operational codes mapped to a language, bit position shift numbers for left shifts; and
generating the MAC in view of the source word access order/priority and the bit session shift numbers.

4. The computer-implemented method of claim 3, wherein K is the secret key, and wherein identifying the source word access order/priority is based on the following:
z[0::15]=[Permutation P_{O} of the 1st 16 bits of K, P₀: {0, 1, . . . , 15}]
z[16::31]=[Permutation P₁ of the 2nd 16 bits of K, P₀: {16, 17, . . . , 31}]
z[32::47]=[Permutation P₂ of the 3rd 16 bits of K, P₀: {32, 33, . . . , 47}
z[48::63]=[Permutation P₃ of the 4th 16 bits of K, P₀: {48, 49, . . . , 63}]

5. The computer-implemented method of claim 3, wherein K is the secret key, wherein Oᵢ represents a respective operation code mapped to a particular equation in the language, and wherein determining bit position shift numbers for left shifts is based on the following:
s[0::63]=[Permutation P_{S} of the second 64 bits of K, P_{S}:{0, 1, . . . , 63}→{Oᵢ|0≦Oᵢ≦63}.

6. The computer-implemented method of claim 1, further comprising authenticating the message using the MAC.

7. A computing device comprising:
a processor; and
a memory coupled to the processor, the memory comprising computer-program instructions executable by the processor for implementing a dynamic code-based hashing for message authentication code generation, the computer-program instructions when executed by the processor performing steps comprising:
receiving a message of arbitrary length and a secret key;
building a hash function using details of the message and the secret key to: (a) permute an order to access source words of the message, and (b) define, in view of operations in a language L, a number of bit positions for left shifts/rotates in a compression function; and
generating a message authentication code (MAC) to authenticate the message.

8. The computing device of claim 7, wherein the secret key is a 192-bit secret key.

9. The computing device of claim 7, wherein building the hash function further comprises using a language and a language interpreter with an operational structure based on characteristics of the message.

10. The computing device of claim 7, wherein building the hash function further comprises identifying an order for performing hash function stages based on the values of the secret key.

11. The computing device of claim 7, wherein building the hash function further comprises determining a number of bit positions for left shifts based on the values of the secret key.

12. The computing device of claim 10, wherein K is the secret key, and wherein identifying the order for performing hash function stages comprises:
z[0::15]=[Permutation P_{O} of the 1st 16 bits of K, P₀: {0, 1, . . . , 15}]
z[16::31]=[Permutation P₁ of the 2nd 16 bits of K, P₀: {16, 17, . . . , 31}]
z[32::47]=[Permutation P₂ of the 3rd 16 bits of K, P₀: {32, 33, . . . , 47}
z[48::63]=[Permutation P₃ of the 4th 16 bits of K, P₀: {48, 49, . . . , 63}]

13. The computing device of claim 12, wherein K is the secret key, wherein Oᵢ represents a respective operation code mapped to a particular operation of the operations in the language L, and wherein determining the number of bit positions for left shifts comprises:
s[0::63]=[Permutation P_{S} of the second 64 bits of K, P_{S}:{0, 1, . . . , 63}→{Oᵢ|0≦Oᵢ≦63}.

14. A tangible computer-readable medium comprising computer-program instructions executable by a processor, the computer-program instructions when executed by the processor for performing operations comprising:
receiving a message and a secret key;
building, based on respective portions of the secret key and a language interpreter, a hash function; and
hashing, using the hash function, a formatted message to generate a message authentication code (MAC) for authentication of the message.

15. The tangible computer-readable medium of claim 14, wherein operations for hashing comprise operations that utilize a language and a language interpreter that is based on characteristics of the message.

16. The tangible computer-readable medium of claim 14, wherein operations for building the hash function further comprise operations for:
identifying, based on respective portions of the secret key, a source word access order/priority to access source words of the formatted message;
determining, based on respective portions of the secret key and operational codes mapped to a language, bit position shift numbers for left shifts; and
generating the MAC in view of the source word access order/priority and the bit session shift numbers.

17. The tangible computer-readable medium of claim 15, wherein K is the secret key, and wherein operations for identifying the source word access order/priority is based on the following operations:
z[0::15]=[Permutation P_{O} of the 1st 16 bits of K, P₀: {0, 1, . . . , 15}]
z[16::31]=[Permutation P₁ of the 2nd 16 bits of K, P₀: {16, 17, . . . , 31}]
z[32::47]=[Permutation P₂ of the 3rd 16 bits of K, P₀: {32, 33, . . . , 47}
z[48::63]=[Permutation P₃ of the 4th 16 bits of K, P₀: {48, 49, . . . , 63}]

18. The tangible computer-readable medium of claim 15, wherein K is the secret key, wherein Oᵢ represents a respective operation code mapped to a particular equation in the language, and wherein operations for determining bit position shift numbers for left shifts is based on the following operations:
s[0::63]=[Permutation P_{S} of the second 64 bits of K, P_{S}:{0, 1, . . . , 63}→{Oᵢ|0≦Oᵢ≦63}.

19. The tangible computer-readable medium of claim 14, further comprising authenticating the message using the MAC.

20. The tangible computer-readable medium of claim 14, wherein the secret key is a 192-bit secret key.
